(19) United States
(12) Patent Application Publication
(10) Pub. No.: US 2002/0141127 A1
(43) Pub. Date: Oct. 3, 2002

(54) Modular surge protection system

(75) Inventor: Robert L. Daugherty, Largo, FL (US)

Correspondence Address: Andrew C. Greenberg, Carlton Fields, P.A., P.O Box 3239, Tampa, FL, 33601-3239, US

(73) Assignee: Diversified Technology Group, Inc.

(21) Appl. No.: 09/801,207

(22) Filed: Mar. 7, 2001

(51) Int. Cl. H02H 3/20

(52) U.S. Cl. 361/111; 361/91.1

(57) ABSTRACT

A surge protection system to monitor and protect AC power lines, telephone/data transmission lines and coaxial cable lines together with associated devices and circuits comprising an AC power protection section, a communication protection section and a cable protection section wherein each protection section includes at least one surge protector comprising a modular surge device and corresponding surge protection circuitry to limit the surge of power therethrough to protect AC power line, telephone/data transmission lines and coaxial cable line together with devices and circuits used in association therewith from a surge of power exceeding a predetermined level and an AC power monitoring section to monitor and indicate the operating status and state of the AC power protection section.

### BACKGROUND OF THE INVENTION

1. Field of the Invention

A surge protection system comprising a plurality of modular surge protectors to protect AC power lines, telephone/data transmission lines and coaxial cable lines and associated devices and circuits from transient power surges.

2. Description of the Prior Art

AC power lines, telephone lines, data lines or coaxial cable lines are subject to occasional power surges of current and/or voltage that can cause permanent damage to devices coupled to such lines. These power surges are commonly caused by grid switching, induction loads, lightning or short circuits.

Surge protectors have been developed to detect and block in a line before reaching a device coupled thereto. There are various types of surge protectors for the different types of electrical or transmission lines.

When a surge suppressor fails in a telephone, security, fire alarm or gate entry system the indication is a “trouble on line” message or a fault signal on the annunciator panel. Either situation must be addressed immediately because the sensing/alarm system may have stopped functioning. Often a technician must be dispatched to find the problem, which may be the system sensor, the wiring from the sensor to an intermediate junction box, the main panel board, or the surge suppressor.

Thus, there is a need for a replacement surge protector or surge suppressor capable of being installed by a non-technical person without specialized training in surge protectors or surge suppressors.

### SUMMARY OF THE INVENTION

The present invention relates to a surge protection system comprising a housing configured to operatively receive and support an AC power protection section, a cable protection section and a communication protection section to protect the AC power lines, coaxial cable lines and telephone/data transmission or communication lines together with associated devices and circuits from transient power surges. The housing may be advantageously located near the point of service entry for a building to provide “whole house” protection for the building.

The AC power protection section comprises a plurality of modular AC power surge protectors removably coupled or mounted to a corresponding module receptacle formed in a front panel of the housing and AC power surge circuitry to protect corresponding AC power lines and associated devices and circuits.

The cable protection section comprises a plurality of modular cable surge protectors removably coupled or mounted to a corresponding module receptacle formed on the front panel of the housing to protect corresponding coaxial cable lines. Each modular cable surge protector includes cable surge protection circuitry to limit the surge of power therethrough to a predetermined level to protect associated devices and circuits.

The communication protection section comprises a plurality of modular communication surge protectors removably coupled or mounted to a corresponding module receptacle formed on the front panel of the housing to protect corresponding coaxial cable lines. Each modular communication surge protector includes communication surge protection circuitry to limit the surge of power therethrough to a predetermined level to protect associated devices and circuits.

When the housing is secured in place, the modular surge protectors for telephone/data lines, coaxial cable lines and for each mode of AC power (L-L, L-N, L-G) are installed. These surge modules are simple plug-in modules that require no wiring or tools for installing or replacement.

Once installed, the modular surge protectors will absorb a power surge great enough to destroy the internal surge components of the surge protection circuitry associated with particular line and modular surge protector experiencing the power surge. The failed modular surge protector can then be replaced as easily as a fuse.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a front view of the surge protection system of the preferred embodiment of the present invention.

FIG. 2 is a schematic view of the AC power section of the preferred embodiment of the present invention.

FIG. 3 is a detailed schematic view of the modular AC power surge protector of the AC power section of the preferred embodiment of the present invention.

Similar reference characters refer to similar parts throughout the several views of the drawings.

### DETAILED EMBODIMENT OF THE PREFERRED EMBODIMENT

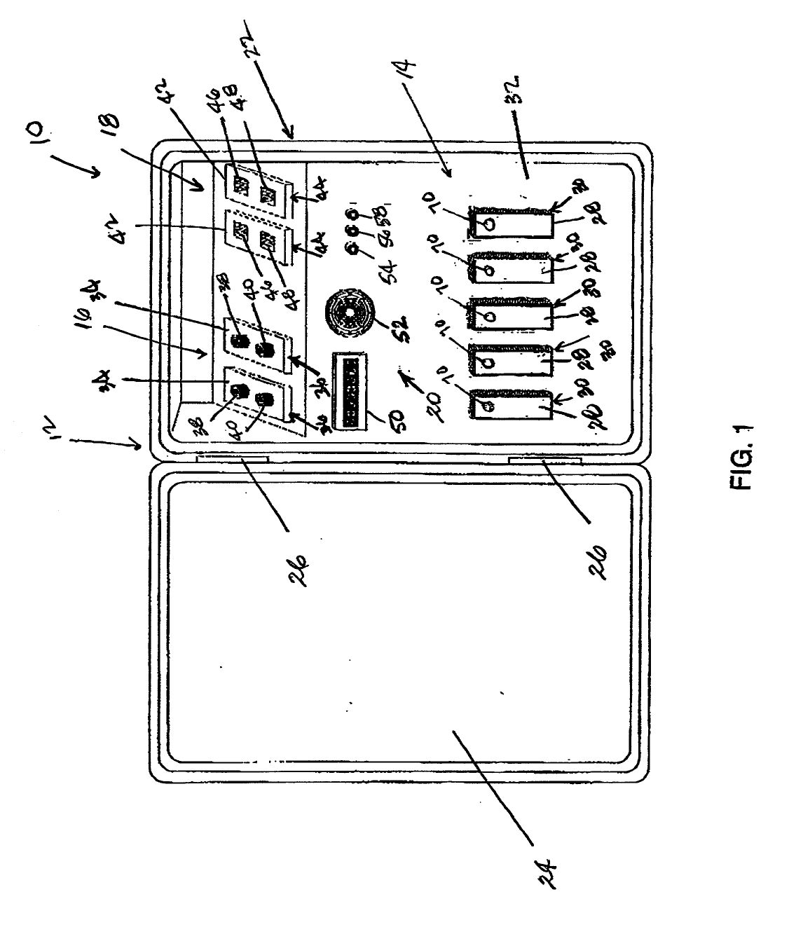

As shown in FIG. 1, a preferred embodiment of the present invention relates to a surge protection system generally indicated as 10 to monitor and protect AC power lines, coaxial cable lines and telephone/data transmission or communications lines together with associated devices and circuits from transient power surges.

The surge protection system 10 comprises a housing generally indicated as 12 configured to operatively receive and support an AC power protection section generally indicated as 14, a cable protection section generally indicated as 16 and a communication protection section generally indicated as 18 to protect the AC power lines, coaxial cable lines and telephone/data transmission or communication lines together with associated devices and circuits from transient power surges. The surge protection system 10 may further include an AC power monitoring section generally indicated as 20 to monitor and indicate the operating status and state of the AC power protection section 14.

As shown in FIG. 1, the housing 12 comprises a compartment generally indicated as 22 having a lid or cover 24 hingedly coupled thereto by a pair of hinges each indicated as 26 to operatively house surge protection circuitry and indicators as described hereinafter.

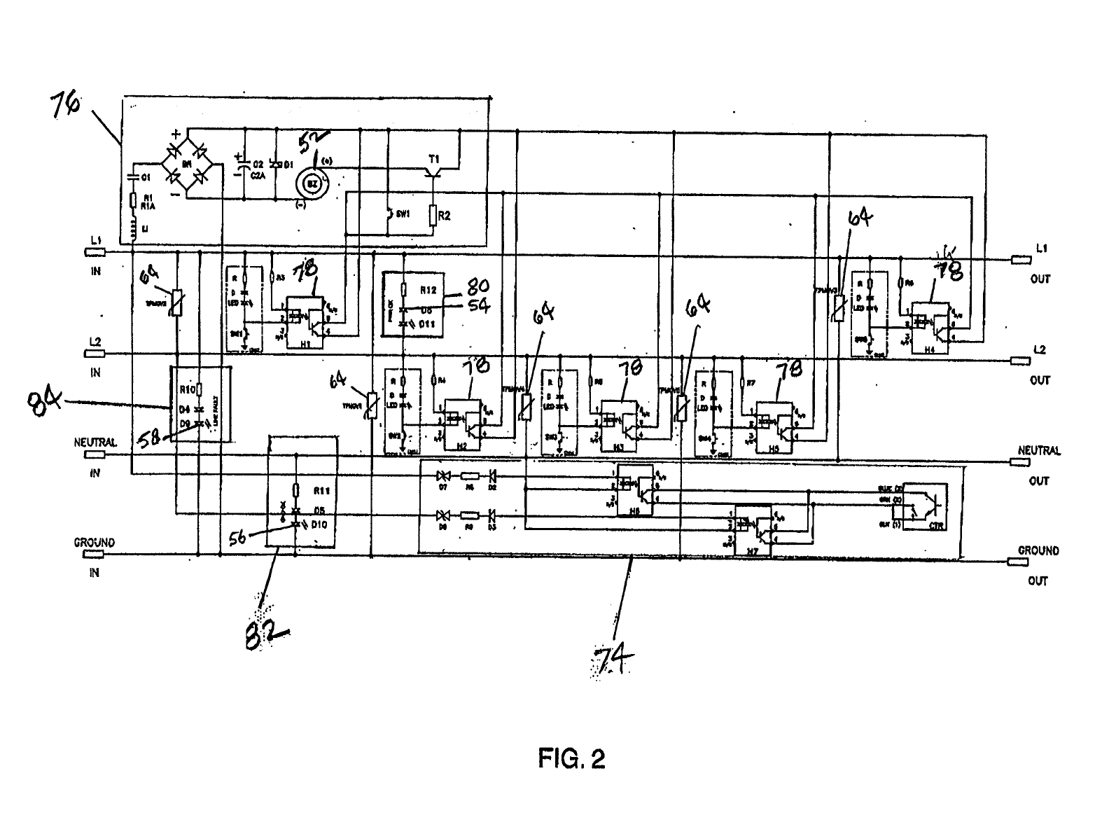

As shown in FIG. 1, the AC power protection section 14 comprises a plurality of modular AC power surge protectors each indicated as 28 removably coupled or mounted to a corresponding module receptacle 30 formed in a front panel 32 of the compartment 22 of the housing 12 and AC power surge circuitry described hereinafter with reference to FIG. 2 to protect corresponding AC power lines and associated devices and circuits (not shown).

As shown in FIG. 1, the cable protection section 16 comprises a plurality of modular cable surge protectors each indicated as 34 removably coupled or mounted to a corresponding module receptacle 36 formed on the front panel 32 of the compartment 22 of the housing 12 to protect corresponding coaxial cable lines. The modular cable surge protectors 34 may comprise a digital satellite cable or cable television surge module or similar surge protector having a line-in port or connector 38 and a corresponding line-out port or connector 40. Each modular cable surge protector 34 includes cable surge protection circuitry to limit the surge of power therethrough to a predetermined level to protect associated devices and circuits (not shown) on the corresponding line-out port or connector 40 from a power surge on the corresponding line-in port or connector 38 when the power fed to the corresponding cable surge protection circuitry exceeds a predetermined power level.

As shown in FIG. 1, the communication protection section 18 comprises a plurality of modular communication surge protectors each indicated as 42 removably coupled or mounted to a corresponding module receptacle 44 formed on the front panel 32 of the compartment 22 of the housing 12 to protect corresponding coaxial cable lines. The modular communication surge protectors 42 may comprise a RJ-45 or category 5 data surge module or similar surge protector having a line-in port or connector 46 and a corresponding line-out port or connector 48. Each modular communication surge protector 42 includes communication surge protection circuitry to limit the surge of power therethrough to a predetermined level to protect associated devices and circuits (not shown) on the corresponding line-out port or connector 48 from a power surge on the corresponding line-in port or connector 46 when the power fed to the corresponding communications surge protection circuitry exceeds a predetermined power level.

As shown in FIG. 1, the AC power line monitor section 20 comprises an AC surge counter 50 to provide a visual numeric count of the number of power surges above a predetermined level sensed or registered by the AC power line monitor section 20 from line 1 (L1) and line 2 (L2), an audible indicator or buzzer 52 energized or activated when any modular AC power surge protector 28 has failed when sensing a voltage surge greater than a second predetermined value and a plurality of lamps or visual indicators 54, 56 and 58 to provide a visual diagnostic display or indication of state and status of the AC power line monitor section 20 such as power on, ground check and line fault respectively in accordance with the following table:

| | Power On | Ground OK | Line Fault |
|---|---|---|---|
| Correct Hook-up | ON | ON | OFF |
| Open Ground | ON | OFF | OFF |
| Open Neutral | OFF | ON | OFF |
| Open Hot | OFF | OFF | OFF |
| Hot/Ground Reversed | OFF | ON | ON |
| Hot/Neutral Reversed | ON | OFF | ON |
| Hot on Neutral with Hot Open | OFF | OFF | ON |

As shown in FIG. 2, the AC power surge circuitry comprises a plurality of AC power lines including an L1, L2, neutral and to provide or produce a plurality of voltages such as L1-L2 at 240 v, L1-N at 120 v, L2-N at 120 v, L1-G at 120 v, L2-G 120 v and N-G Ov having a plurality of shunts such as metal oxide varistors each indicated 64 coupled across the various AC power lines and each corresponding to one of the plurality of modular AC power surge protectors 28.

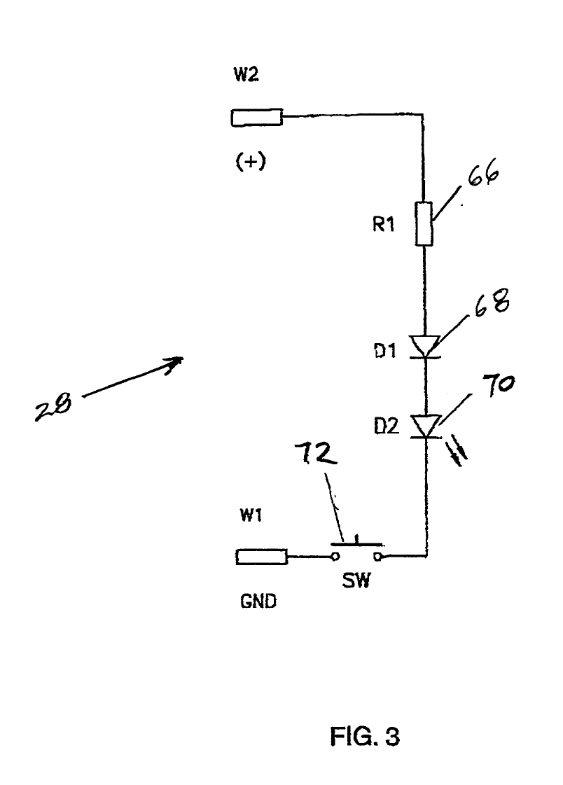

As best shown in FIG. 3, each modular AC power surge protector 28 comprises a resistor, diode, light emitting diode and switch indicated as 66, 68, 70 and 72 respectively configured to close the switch 72 and to conduct when the voltage across the corresponding shunt or metal oxide varistor 64 exceeds the second predetermined level or value to illuminate the corresponding light emitting diode 70 and to activate or energize the audible indicator or buzzer 52 as described hereinafter. The switch 72 may comprise a thermally protected metal oxide varistor or other destructible current element. As depicted, each modular AC power surge protector 28 is electrically coupled to ground and therefore self-grounding.

As shown in FIG. 2, the AC power protection circuitry includes an AC power surge counter circuit 74 to generate a counter signal fed to the AC power surge counter or indicator 50 to increment or advance the AC power surge counter or indicator 50 when ever the voltage on either AC power line L1 or line L2 exceeds the nominal line voltage by a first predetermined voltage. The AC power surge counter circuitry 74 includes a zener diode, resistor, diode and optoisolator coupled between a counter switch and the AC power lines L1 and L2.

As shown in FIG. 2, the AC power protection circuitry includes an AC power surge indicator circuit 76 comprising an inductor, resistor and capacitor, bridge rectifier, capacitor, zener diode, buzzer 52, resistor and transitor and an AC power surge protector switch or coupler 78 such as an optoisolator corresponding to each modular AC surge protector 28 to generate a signal to energize or activate the audible indicator or buzzer 52 when any modular AC power surge protector 28 has failed when sensing a voltage surge greater than the second predetermined value.

As shown in FIG. 2, the AC power protection circuitry includes a power check circuit 80 comprising a resistor, diode and light emitting diode 54 electrically coupled between L1 and L2 to illuminate the power-on lamp or visual indicator 54 when voltage is applied to either AC power line L1 or L2, a ground check circuitry 82 comprising a resistor, diode and light emitting diode electrically coupled between AC power lines L1 and L2 to illuminate a check to the ground check light emitting diode 56 when the voltage potential between the neutral line and the ground line is greater than a predetermined value or amount such as 5 volts and line fault circuit 84 comprising a resistor, diode and the light emitting diode 58 electrically coupled between L1 and L2 to illuminate the lamp or indicator 58 to indicate power on AC power line L1.

When the housing 12 is secured in place, the modular AC power surge protectors 28, modular cable surge protectors 34 and modular communication surge protectors 42 are installed on the front panel 32 of the compartment 22 of the housing 12 in the corresponding modular receptables 30, module receptacles 36 and modular receptacles 44 respectively. The housing 12 may be advantageously located at the point of service entry for a building to provide “whole house” protection for the building. So set up, the lamps or visual indicators 54, 56, and 58 provide a visual indication of state and status of the AC power line monitor section 20 such as power on, ground check or line fault.

Separate modular surge protection modules for telephone/data lines, coaxial cable lines and each mode of AC power (L-L, L-N, L-G) are simple plug-in modules that require no wiring or tools to install or replace.

When the surge protection system 10 is installed and connected to AC power lines, coaxial cable lines and telephone/data transmission or communication lines, the surge protector device 10 will absorb a power surge of voltage great enough to destroy the internal surge components of the surge protection circuitry as previously described.

When a modular AC power surge protector 28 fails, the modular AC power surge protector 28 signals the user by means of the light 70 and audible alarm 52. In the preferred embodiment, the light 70 can signal failure to the user not only by changing from a normally active or lit state to a normally passive or unlit state, but can also signal failure by changing from a normally passive or unlit state to an active or lit state; or from a normally steady state to a varying or blinking state. The user simply unplugs or removes the failed module AC power surge protector 28 and replaces the AC power surge protector 28 with a new AC power surge protector 28. The communications and coaxial modules 42 and 34 do not contain a light nor audible alarm.

In other words, the audible indicator 52 alerts the homeowner that a modular AC power surge protector 28 has failed. The corresponding light emitting diode 70 is illuminated when the modular AC power surge protector 28 needs to be replaced. To replace the failed AC power module 28, the homeowner simply grasps the failed modular AC power surge protector 28 with thumb and finger and gently pull up and away from the front panel 32 and inserts or installs a new modular AC power surge protector 28 into the corresponding modular receptacle 30. No tools are needed.

A failed modular communication surge protector 42 or modular cable surge protector 34 is indicated by static and hum in the telephone and by interference lines on the television picture respectively. If a failed modular communication surge protector 42 or modular cable surge protector 34 is responsible for this line noise, the condition is corrected by replacing the modular communication surge protector 42 or modular cable surge protector 34. The failed modular communication surge protector 42 or modular cable surge protector 34 is removed by loosening the screws holding the modular communication surge protector 42 or modular cable surge protector 34 and withdrawn from the corresponding modular receptacles 44 or 36 and replaced with a new modular communication surge protector 42 or modular cable surge protector 34.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A surge protection system to monitor and protect AC power lines together with associated devices and circuits comprising an AC power protection section having at least one modular AC power surge protector comprising a modular AC surge device and corresponding surge protection circuitry to limit the surge of power therethrough to protect the AC power lines together with the devices and circuits used in association therewith from a surge of voltage exceeding a predetermined level.

2. The surge protection system of claim 1 wherein said AC power protection section comprises a switch electrically coupled to ground to ground said AC power protection section when said predetermined level is exceeded.

3. The surge protection system of claim 2 further comprises a compartment having a front panel and said modular AC power surge device is removably mounted to a corresponding module receptacle formed in said front panel.

4. The surge protection system of claim 3 wherein said AC power protection section comprises an indicator to indicate when the voltage across said modular surge exceeds said predetermined level.

5. The surge protection system of claim 4 further comprising an AC power monitor section to monitor and indicate the operating status of said AC power protection section.

6. The surge protection system of claim 5 wherein said AC power monitor section includes an audible indicator when modular AC power surge protector has failed when sensing a voltage surge greater than said predetermined value.

7. The surge protection system of claim 6 wherein said AC power monitor section further includes a plurality of visual indicators to provide a visual indication of state of said AC power protection section.

8. The surge protection system of claim 7 said plurality of visual indicators includes a power on indicator and a ground check indicator.

9. The surge protection system of claim 5 wherein said AC power monitor section comprises a plurality of visual indicators to provide a visual indication of state of said AC power protection section.

10. The surge protection system of claim 6 wherein said AC power monitor section further comprises an AC surge counter to provide a numeric count of the of voltage surges greater than second predetermined level across said AC power protection section.

11. The surge protection system of claim 3 further including a circuit element disposed in electrically parallel relationship relative to said switch element to conduct electricity therethrough when a surge of voltage through said switch exceeds said predetermined level.

12. A surge protection system to monitor and protect AC power lines, telephone/data transmission lines and coaxial cable lines together with associated devices and circuits comprising an AC power protection section, a communication protection section and a cable protection section wherein each said protection section includes at least one surge protector comprising a modular surge device and corresponding surge protection circuitry to limit the surge of power therethrough to protect the AC power lines, telephone/data transmission lines and coaxial cable lines together with the devices and circuits used in association therewith from a surge of power exceeding a predetermined level.

13. The surge protection system of claim 12 wherein said AC power protection section comprises a switch electrically coupled to ground to ground said AC power protection section when said predetermined level is exceeded.

14. The surge protection system of claim 13 further comprising a compartment having a front panel and each said modular surge device is removably mounted to a corresponding plurality module receptacle formed in said front panel.

15. The surge protection system of claim 14 wherein said AC power protection section comprises an indicator to indicate when the voltage across said modular surge exceeds said predetermined level.

16. The surge protection system of claim 15 further comprising an AC power monitor section to monitor and indicate the operating status of said AC power protection section.

17. The surge protection system of claim 16 wherein said AC power monitor section includes an audible indicator when modular AC power surge protector has failed when sensing a voltage surge greater than said predetermined value.

18. The surge protection system of claim 17 wherein said AC power monitor section further includes a plurality of visual indicators to provide a visual indication of state of said AC power protection section.

19. The surge protection system of claim 18 said plurality of visual indicators includes a power on indicator and a ground check indicator.

20. The surge protection system of claim 19 wherein said AC power monitor section comprises a plurality of visual indicators to provide a visual indication of state of said AC power protection section.

21. The surge protection system of claim 17 wherein said AC power monitor section further comprises an AC surge counter to provide a numeric count of the of voltage surges greater than second predetermined level across said AC power protection section.

22. The surge protection system of claim 14 wherein each said modular surge device further includes a circuit element disposed in electrically parallel relationship relative to said switch element to conduct electricity therethrough when a surge of voltage through said switch exceeds said predetermined level.to provide a visual indication of state of said AC power protection section.

23. The surge protection system of claim 5 wherein said AC power monitor section includes a power check circuit comprising a light emitting diode electrically coupled to the AC power line to illuminate when voltage is applied to the AC power lines.

24. The surge protection system of claim 23 wherein said AC power monitor section further includes a ground check circuitcomprising a light emitting diode electrically coupled between the AC power lines to illuminate when the voltage potential between the neutral line and the ground line is greater than a predetermined value.

25. The surge protection system of claim 16 wherein said AC power monitor section includes a power check circuit comprising an emitting diode electrically coupled to the AC power line to illuminate when voltage is applied to the AC power lines.

26. The surge protection system of claim 25 wherein said AC power monitor section further includes a ground check circuit comprising a light emitting diode electrically coupled between the AC power lines to illuminate when the voltage potential between the neutral line and the ground line is greater than a predetermined value.

27. The surge protection system of claim 5 wherein said AC power monitor section includes a visual indicator when modular AC power surge protector has failed for signaling failure by changing from a normally passive state to an active state.

28. The surge protection system of claim 5 wherein said AC power monitor section includes a visual indicator when modular AC power surge protector has failed for signaling failure by changing from a normally steady state to a varying state.

29. The surge protection system of claim 15 wherein said AC power monitor section includes a visual indicator when modular AC power surge protector has failed for signaling failure by changing from a normally passive state to an active state.

30. The surge protection system of claim 15 wherein said AC power monitor section includes a visual indicator when modular AC power surge protector has failed for signaling failure by changing from a normally steady state to a varying state.
